(19) United States
(12) Patent Application Publication
(10) Pub. No.: US 2011/0062078 A1
(43) Pub. Date: Mar. 17, 2011

(54) MEMBRANE REGENERATION

(75) Inventor: Anais Alice Makardij-Tossonian, Tauranga (NZ)

(73) Assignee: Orica Australia Pty Ltd., Melbourne (AU)

(21) Appl. No.: 12/863,324

(22) PCT Filed: Jan. 16, 2009
(86) PCT No.: PCT/AU2009/000047

§ 371 Date: Oct. 29, 2010

(30) Foreign Application Priority Data
Jan. 16, 2008 (AU) 2008900207

(51) Int. Cl. B01D 65/02; B01D 63/00

(52) U.S. Cl. 210/500.21; 435/262

(57) ABSTRACT

The invention provides a method of regenerating a fouled membrane removed from a process line. The membrane is regenerated by immersing at least a portion of it into an agitated enzyme solution. The agitation is provided by a gas injected into the enzyme solution and is thought to assist enzyme in the enzyme solution to contact the foulant. Also disclosed is a membrane regenerated by the method.

### FIELD OF THE INVENTION

The present invention relates to the regeneration of a fouled membrane that has been used, for example, in food and/or beverage processing equipment such as milk processing equipment.

### BACKGROUND OF THE INVENTION

Membranes are used to separate permeate from a feed supply containing particles by acting as a physical barrier to capture the particles. A membrane has a permeate-side where permeate is collected and a retentate-side where retentate or concentrate that contains particles rejected by the membrane is collected. The permeate filters through the membrane under the influence of a transmembrane pressure differential. Particles that remain on the retentate-side of the membrane can build up over time to foul the membrane, eventually decreasing its permeability.

Any particles can contribute to membrane fouling. Furthermore, fouling can occur on all membrane surfaces including inside any pores. Membrane fouling reduces permeate flow and salt rejection, and increases the differential pressure. Membranes are used for as long as they have the required permeability (measured by flux). However, once the membrane exhibits decreased yield or the transmembrane pressure increases to an unacceptable level, the membrane must be replaced or cleaned. The unacceptable level can be any level pre-determined by, for example, internal or industry standards.

The replacement of membranes represents a considerable cost to industry since new membranes are expensive and a process line using membrane modules must be shut down while new membranes are installed. Furthermore, fouled membranes are costly to dispose of in landfill and also represent an environmental impact.

Rather than being replaced, membranes can be cleaned in situ which is often referred to as CIP or “Cleaning-in-Place”. A traditional Cleaning-In-Place (CIP) procedure for removing foulant from a membrane used in milk processing equipment involves ceasing production, flushing the equipment with water, circulating an alkali solution through the equipment to contact the membranes, flushing the equipment with water, circulating an acid solution through the membrane and flushing/rinsing the equipment with water again. The alkali solution generally comprises caustic soda and the acidic solution is generally a nitric acid or nitric/phosphoric acid blend. Studies show that a membrane cleaned in the process line can exhibit a 40% increase in permeate flow, a 38% decrease in differential pressure and a 3% increase in salt rejection. The acid and/or caustic wash is believed to dissolve or break-down some materials fouling the membrane. These materials or foulants are then removed with the wash in the rinse water.

The caustic wash subjects the membranes to a high pH which has an impact on both the membranes longevity and integrity. Furthermore, even with other CIP cleaning regimes, in some cases, the membrane cannot be cleaned to the required specifications, i.e. the permeability of the membrane cannot be improved to an acceptable level. This can be a particular problem where membranes are arranged in a process line in series, because the foulant from an upstream membrane can get trapped on the next membrane in the series. Foulants that are particularly difficult to remove include fatty and/or proteinaceous materials, which foul membranes used, for example, in the dairy industry.

Accordingly, there exists a need for an effective procedure to remove foulant from a fouled membrane. Such a procedure developed for use in a milk processing plant could be applied, where possible, to membranes used in other processing equipment.

### SUMMARY OF THE INVENTION

According to a first aspect of the invention there is provided a method of regenerating a fouled membrane, the method including the steps of:
immersing at least a portion of the fouled membrane removed from a process line into an enzyme solution; and
injecting a gas into the enzyme solution to agitate the enzyme solution;
wherein the agitation assists enzyme in the enzyme solution to contact the foulant.

The enzyme solution can be in a tank or any other suitable container or receptacle. For convenience, hereinafter reference is made to a tank.

The injection of gas into the enzyme solution creates a jet mixing effect which is believed to assist the enzyme to contact the foulant. When in contact with the foulant, it is thought that the enzyme in the enzyme solution dissolves, breaks-down and/or digests at least some of the foulant, so it can be removed from the membrane. The agitation is also believed to renew the active surface of the enzyme and therefore increase the enzyme activity. The agitation may also assist in the removal of foulant by helping to dislodge it from the membrane and dispersing it into the bulk enzyme solution.

The agitation of the enzyme solution increases the efficiency of the enzyme compared to the same enzyme solution in the absence of agitation. The increased efficiency of the enzyme can be represented by a decrease in the time taken to remove the foulant, a decrease in the amount of enzyme required to remove foulant and/or an increase in the total amount of foulant that is removed from the fouled membrane. It has been found advantageous to increase the temperature of the enzyme solution during agitation to promote or optimise the enzyme activity.

The invention differs from a CIP process in that the membrane is removed from the process line in which it is normally housed. It would not be practical to apply agitation to the membrane in situ in a process line because the membrane is under pressure. The membrane is depressurised before removal from the process line. In one embodiment, the method includes the step of removing the membrane from the process line. Once the membrane has been regenerated by the method it is suitable for reintroduction into the same or a different process line from which it was taken.

The membrane treated by the present process must be capable of being regenerated. There are some membranes that are not capable of being regenerated because the foulant build up on the surfaces has been compacted and has damaged the underlying membrane pore structure. Even once foulant is removed from such a membrane, it is no longer capable of being used as a filtration or separation device in a process line. The skilled addressee would be able to identify a membrane that has been irreparably damaged by foulant. The damage could be inflicted by using the membrane contrary to the operation instructions. For example, running the process line without consideration for the base line temperature and pressures to which the membrane should be subjected and/or continuing to use the membrane for an extended period of time even once the flux has decreased beyond an acceptable level.

Using the present method, foulant amounting to a further 5 to 15 weight percent of the fouled membrane (and possibly more) can be removed compared with the amount of foulant removed by the same enzyme solution contacting the membrane in the absence of agitation (e.g. when the membrane is cleaned in series in a process line (CIP)). This is a significant additional amount of foulant given that foulants such as fatty and proteinaceous materials are low-density.

It is believed the regeneration extends membrane life and improves membrane performance. The method of the present invention is also thought to extend the time needed between the cleaning of the membranes, which lowers direct labour costs.

### DESCRIPTION OF PREFERRED EMBODIMENTS OF THE INVENTION

The method of the invention lends itself in particular to the regeneration of membranes used in the dairy industry, for example, those used in milk, cheese, yoghurt or cream processing equipment. However, membranes from other industries that are fouled with materials that are difficult to remove by traditional CIP processes can be regenerated by the method. For example, membranes used in the brewing industry that are fouled with yeast cells, membranes in the waste water industry that are fouled with biomaterials and/or bacteria or membranes used to process soft drinks or alcoholic beverages such as wine. Embodiments of the invention will be described with particular reference to membranes used in milk processing equipment, but the invention is not so limited.

Some foulant may result in decolourisation of the membrane. This can occur, for example, in the wine industry where tannins in the feed stain the membrane surfaces. It is desirable, to remove the discolouration along with the foulant itself. It may be a commercial advantage to remove discoloration, since discoloured membranes can be perceived as fouled even if the surfaces are not.

In order to regenerate it, the membrane is removed from a process line, which may include a series of pressure vessels. The pressure vessels may be made from stainless steel when used for food applications or may be made of fibre-glass for water treatment applications. The vessels can be configured to house, for example, three to five membrane modules each. Each membrane can be removed by first depressurising the pressure vessel in which it is housed and then removing it. The membrane is completely removed from the vessel and is treated in a separate tank that is not in liquid communication with the process line. Optionally, the membrane is removed and regenerated off-site away from the process line.

The membrane is typically removed from the process line and treated by the method when its permeability (flux) drops below an acceptable level or a period of time has elapsed since its first use. The approximate life span of a membrane will depend upon the application type and run times employed. In dairy applications, membranes are typically replaced once every two seasons (18 months) or when they fail to deliver 60% of normal permeability (measured as the permeability of a virgin membrane (unused)). However, the membrane can be regenerated by the method when there is any amount of foulant on its surface.

The method can be used to regenerate any type of membrane, for example, Microfiltration (MF), Ultrafiltration (UF); Nanofiltration (NF) or Reverse Osmosis (RO) membranes. The method is particularly useful for regenerating spiral wound membranes that have a high packing density, low cost and rugged high-pressure operation. Spiral wound membranes are flat sheet membranes wound into a spiral configuration. There is a pressure differential across the membrane that causes some of the fluid to pass through the membrane, while the remainder continues across the surface. Because of the configuration of these membranes there are particular difficulties associated with keeping the surface of the membrane clean, which, when coupled with the fact that these membranes cannot be backwashed, means they are normally employed only in specific applications. Foulant can be difficult to remove from spiral wound membranes when they are housed in the process line, because foulant debris that is released from the first membrane in the series passes to the downstream membranes. The removal of the membranes from the process line to clean them individually alleviates or at least reduces this problem.

Once removed, the membrane is at least partially immersed into an enzyme solution. The enzyme solution can be in a tank or any other vessel capable of containing the enzyme solution. The membrane can be immersed either partially or wholly into the tank in order that the enzyme solution contacts at least some of the foulant. The enzyme in the enzyme solution will only act on that part of the membrane that is immersed. Preferably, all of the fouled surfaces of the membrane are contacted with the enzyme solution. The most advantageous way of achieving this is to completely immerse the fouled membrane into the tank. Optionally, parts of the membrane that are not wholly acted upon by the enzyme can be re-immersed in the enzyme solution. It is also an option that the immersion of the membrane into the enzyme solution is undertaken more than once to optimise the removal of foulant.

The membrane can be immersed in the enzyme solution for any period of time sufficient to cause the enzyme to dissolve, break-down and/or digest at least some of the material fouling the membrane surface. The time period could be in the range of from about 6 to about 48 hours, however, shorter or longer time periods could be employed. Preferably the membrane is immersed for at least 24 hours to ensure the enzyme has had the opportunity to work. The pH and temperature of the enzyme solution can be selected and maintained to optimise the activity the specific enzyme(s) in solution. The optimum pH and temperature for an enzyme is readily available information for the skilled addressee.

The time period of treatment in the enzyme solution can be selected to remove about 100% of foulant from the membrane. However, removal of at least about 80% or at least about 90% of the foulant may be acceptable depending upon the intended application of the regenerated membrane. For example, membranes intended for use (or re-use) in the waste-water industry need not be regenerated to the same standard as those intended for use (or re-use) in the dairy industry. Accordingly, a regenerated membrane integrity of 80% may be sufficient for the waste-water industry while a regenerated membrane integrity of at least 90% may be required for dairy applications. The removal of foulant could be undertaken until the membrane re-achieves a desired flux. For example, a fouled membrane May have a flux of about 4 Gallons Per Minute (GPM) and is regenerated until the flux is above about 6 GPM. The desired flux of the regenerated membrane will depend upon the type and size of the membrane and can be the same as the flux of a virgin membrane of the same type that has not been previously used.

In order to assist the enzyme to contact at least some of the material fouling the membrane, the solution is agitated by the injection of a gas. In one embodiment, the gas is compressed air, although any gas could be used, for example, nitrogen. The gas injection rate can be in the range of from about 20 to 100 Gallons per Minute (GPM) although it could be higher or lower depending upon the size of the vessel. In one embodiment, the gas injection rate is 50 GPM. The rate of gas injection can be altered by trial and error to effect the desired agitation. The velocity of the jet stream can be in the range of, for example, from about 0.1 to 0.8 ms⁻¹. In one embodiment, the velocity is about 0.5 ms⁻¹.

The gas can be injected into the enzyme solution at a point below the level of the enzyme solution via gas injection apertures. In one embodiment, the gas in injected into a tank using nozzles, such as fine nozzles. Each nozzle can have an aperture for delivering the gas with a diameter in the range of, for example, from about 0.5 mm to about 1 cm, preferably 1 mm to 3 mm. In one embodiment in which the tank is designed to hold about 100 litres of enzyme solution, the gas is injected through a series of apertures of about 2 mm formed in a pipe. Compressed air can be delivered to the pipe at a pressure of about 150 psi to 250 psi, preferably about 200 psi. The apertures can be spaced along the pipe within a few centimetres from one another, for example about 5 cm or about 10 cm from one another along the length of the pipe. Larger or smaller diameter apertures could be used provided the desired velocity in the tank is reached. The gas can be injected in a continuous stream or pulsed into the tank to increase the agitation effect. The pulsation of gas into the tank is thought to assist in continually providing fresh enzyme to the fouled surfaces of the membrane.

The gas injection apertures can be distributed throughout the tank including on the side and bottom surfaces. Where the membrane is a spiral wound membrane, advantageously, the apertures are located on the side walls of the tank and the membrane is immersed into the tank horizontally. The bubbles of gas injected are thereby able to penetrate into the membrane spiral windings and liquid is able to flow through the membrane from one side to another. Optionally, the jet apertures are evenly spaced across the entire surface of the side walls of the tank to deliver the gas bubbles to the membranes and agitate the solution therein. Alternatively, there are rows of apertures towards the bottom surface and towards the top surface of the tank to provide agitation.

In embodiments in which more than one membrane is immersed in the enzyme solution, the membranes can be displaceably suspended in the enzyme solution. The membranes can be displaced so as to be at least substantially evenly exposed to the jet mixing effect provided by the injection of gas. This may be necessary where there are fewer jets in the tank, for example, a line of apertures towards the bottom of the tank only.

In addition to gas injection, the enzyme solution in the tank can be further agitated. The further agitation could be provided by, for example, vibration, sonication or mechanical stirring to encourage the enzyme in the solution to penetrate the membrane and contact the foulant. These types of agitation are preferably used in combination with gas agitation.

The enzyme solution can be prepared in any way. In one embodiment, powdered enzyme is added to a liquid to prepare the solution. The concentration of enzyme in the enzyme solution is preferably in excess of that needed to dissolve, digest and/or break-down all of the foulant present on the membrane or membranes immersed in the solution. The required concentration could be calculated based on the amount of foulant present. Alternatively, an enzyme solution having an enzyme concentration in the range of from about 0.1 ML⁻¹ to about 0.3 ML⁻¹ could be used. More enzyme could be used if necessary and less could be used if there is only minimal fouling as would be appreciated by the skilled addressee based on the teachings of the present specification.

The enzyme for use in the enzyme solution can be selected in accordance with the type of foulant material fouling the membrane. The composition of the foulant could be determined by experiment (sometime referred to as an autopsy) or the skilled person could know the composition based on past experience or predict the composition based on the types of materials that have been passed through the membrane.

Where the foulant includes proteinaceous material, the enzyme solution can include any proteolytic enzyme, e.g. protease, which is known to break down proteins. A 1% to 10% liquid protease solution could be used, optionally including a buffering agent. For example, a protease only enzyme cleaner that could be used is Reflux E1000. If the foulant includes fats, the enzyme solution can include lipase which is known to break down fats. If both protein and fat is present, a lipase and protease mixture could be used. An example of a lipase/protease source is Reflux E2001 (lipase+protease), which contains 60% active ingredients and a buffering agent.

There is no limitation on the enzyme or enzyme combinations that could be used. Other enzymes that could be used include amylase and/or cellulase, which will target carbohydrate-type foulants. It may be appropriate to use mannanase and/or carrageenase if the membrane is fouled with polysaccharides such as mannans and/or carrageenans which can be found, for example in plant matter material. If protein, fats and carbohydrates foul the membrane a solution of lipase, protease, amylase and cellulase could be used. For example, Reflux E4000 (lipase+protease+amylase+cellulase) may be appropriate. Reflux E4000 contains 10% active ingredients as well as a buffering agent and <1% sodium hydroxide.

In milk processing equipment, the foulant is likely to include proteinaceous material such as milk proteins, e.g. casein and whey, as well as fats, carbohydrates, minerals and micro-organisms. Other foulants that can exist on membranes from other industries include yeast cells, biofilm, fibres and clays. While such fouled membranes can be treated with a traditional CIP process, the complexity of the foulant means the membranes can be difficult to regenerate using only a CIP method.

An enzyme that targets the fouling material can be more specific and therefore more effective than a process in the absence of enzymes. The enzyme used can be tailored to the type of foulants or a combination of enzymes can be used since these will target a spectrum of foulants including yeast cells, clays and biofilm.

The enzyme solution may contain surfactants or detergents, such as polyalkene glycols, which can improve the wettability of the foulant. The surfactants may be chosen to be suitable for use in the industry in which the membrane is used. For example, for membranes used in the food industry, anionic, non-ionic or amphoteric surfactants may be used. An example of a surfactant that could be used in the food industry is Reflux A230. The enzyme solution may also further comprise one or more defoamers, which reduces foam production.

It has now been found that increasing the temperature of the enzyme solution increases the effectiveness of the enzyme. The temperature can be increased to the known optimum operating temperature of the enzyme or enzymes used. In embodiments, in which protease, lipase, amylase and cellulase (e.g. Reflux E4000) is used, the temperature is increased to be in the range of from about 28° C. to about 55° C., preferably the temperature is about 45° C. to about 50° C. The temperature can be maintained for the entire period during which the membrane is immersed in the enzyme solution. Alternatively, the temperature is increased to e.g. about 50° C. and then the temperature of the enzyme solution is allowed to equilibrate with the surrounding environment. Any decrease in temperature can be mitigated by the use of an insulated tank.

Once the membrane has been immersed in the enzyme solution and agitated for a period of time, it is removed and rinsed e.g. with water. Further processes can then be undertaken to remove any residual foulant. In some instances, further processes may be necessary in order to regenerate the membrane to the required integrity. These further processes can include acid and caustic washes/rinses which can be undertaken as a CIP process. A simulated process line can be used to undertake the CIP if desired. The further cleaning process(es) chosen can be a standard procedure similar to the existing procedure used in that industry. Alternatively, the further cleaning could be tailored to accommodate the residual foulant on the membrane. This tailoring may depend upon the composition and amount of fouling on the membrane. For example, if the foulant includes biofilm a hydrogen peroxide and per acetic acid formulated sanitiser could be used to degrade the biofilm. Where the fouling includes minerals, an acid wash may be required before a caustic wash as would be appreciated by the skilled person.

Following regeneration, the membrane can be returned to a customer or resold. If the membrane is packed into a bag, preferably the bag is filled with a preservative to reduce bacterial contamination in, the membrane during storage.

### EXAMPLES

The invention will now be described with reference to the following non-limiting examples.

### Example 1

### Removal of Protein from UF Membranes Used in Milk Processing

Eight fouled UF membranes (spiral wound) were removed from a milk processing line. Before being regenerated, the initial permeate flow rate (flux) of the fouled membrane (in GPM), initial Total Dissolved Solids (TDS) and initial pressure measurements were taken. The results are shown in Table 2 below. In the Tables, the membranes are referred to as “modules”.

Since the foulant was likely to be mostly proteinaceous material (i.e. milk proteins), each membrane was immersed horizontally, overnight into an insulated tank containing four kilograms of protease enzyme in 100 litres of an alkaline solution such as Reflux B615. The concentration of enzyme in solution was about 0.2 ML⁻¹. The protease solution contained a non-ionic surfactant (Reflux A320). The pH of the enzyme solution was adjusted to be in the range of 9 and 10. The temperature of the enzyme solution was initially increased to about 45° C., but this temperature was not maintained.

The solution was agitated by application of compressed air by a centrifugal pump designed to deliver 200 psi. The tank comprised a line of apertures of about 2 mm in diameter spaced about 10 cm apart in a pipe positioned about 20 cm from the base of the tank. After 24 hours of agitation in the tank, the membrane was removed and rinsed with water. The temperature of the enzyme solution had dropped to about 35° C. to 40° C.

For further cleaning, each membrane was installed into a pressurised vessel and subjected to the CIP process outlined in Table 1. The regime was selected to be applicable for dairy membranes. The alkali recirculation was a 10% caustic soda solution and the acid solution was 10% hydrochloric acid. The temperatures indicated were maintained over the given time period.

TABLE 1
Caustic/Acid/Caustic CIP Regime

| | | Vol | Time | Temp | |
|---|---|---|---|---|---|
| Step | Solution | (L) | (min) | (° C.) | PH |
| 1. Water flush | | | 8 | | |
| 2. Alkali Recirculation | Reflux B615 | 15 | 30 | 50 | 10.8-11.0 |
| 3. Water Flush | | | 8 | | |
| 4. Acid Recirculation | Reflux R400 | 16 | 30 | 50 | 1.8-2.0 |
| 5. Water Flush | | | 8 | | |
| 6. Alkali Recirculation | Reflux B615 | 15 | 30 | 50 | 10.8-11.0 |
| 7. Water Flush | | | 8 | | |

The permeate flow of the membrane and TDS were monitored following treatment to evaluate the regeneration process. The results are shown in Table 2. The results show a recovery rate of around 60% while salt rejection rate was above 97% following regeneration.

TABLE 2
Initial and Final Data

| | Permeate | | | | | | | | |
|---|---|---|---|---|---|---|---|---|---|
| Mod- | Flow | | % Flow | Pressure | | TDS | | Rejection | |
| ule | (gpm) | | Re- | (Psi) | | (ppm) | | % | |
| # | Initial | Final | covery | Initial | Final | Initial | Final | Initial | Final |
| 1 | 4.0 | 6.5 | 63 | 5 | 5 | 32 | 30 | 98.4 | 98.5 |
| 2 | 4.0 | 6.8 | 70 | 5 | 5 | 24 | 22 | 98.8 | 98.9 |
| 3 | 4.0 | 6.5 | 63 | 5 | 5 | 30 | 28 | 98.5 | 98.6 |
| 4 | 4.0 | 6.8 | 70 | 5 | 5 | 200 | 34 | 90 | 98.3 |
| 5 | 4.5 | 6.8 | 50 | 5 | 5 | 32 | 22 | 98.4 | 98.9 |
| 6 | 4.5 | 6.5 | 55 | 5 | 5 | 40 | 20 | 98 | 98.8 |
| 7 | 4.3 | 6.8 | 59 | 5 | 5 | 46 | 20 | 97.7 | 99 |
| 8 | 4.5 | 6.8 | 50 | 5 | 5 | 230 | 58 | 88.5 | 97.1 |

To assess the regenerated membrane's integrity, a comparison was undertaken with a brand new membrane (virgin membrane). The results are shown in Table 3.

TABLE 3
Module Integrity Data

| | Recovered | Virgin | Membrane |
|---|---|---|---|
| Module # | Flow (gpm) | Flow (gpm) | Integrity % |
| 1 | 6.5 | 7.4 | 88 |
| 2 | 6.8 | 7.4 | 90 |
| 3 | 6.5 | 7.4 | 88 |
| 4 | 6.8 | 7.4 | 92 |
| 5 | 6.8 | 7.4 | 92 |
| 6 | 6.5 | 7.4 | 88 |
| 7 | 6.8 | 7.4 | 92 |
| 8 | 6.8 | 7.4 | 92 |

The membranes were weighed before and after regeneration to evaluate the amount of foulant removed during the regeneration process. An average of 1.3 kilograms (about 9% of the total weight of the fouled membrane) of solid foulant was removed. Results are listed in Table 4.

TABLE 4
Weight Analysis

| | | | Weight | % |
|---|---|---|---|---|
| Module | Weight (kg) | | Removed | Weight |
| # | Initial | Final | (kg) | Removed |
| 1 | 13.6 | 12.6 | 1.0 | 7.4 |
| 2 | 13.8 | 12.4 | 1.4 | 10.1 |
| 3 | 13.6 | 12.2 | 1.4 | 10.3 |
| 4 | 13.6 | 12.4 | 1.2 | 8.8 |
| 5 | 13.8 | 12.6 | 1.2 | 8.7 |
| 6 | 13.6 | 12.4 | 1.2 | 8.8 |
| 7 | 13.8 | 12.4 | 1.4 | 10.1 |
| 8 | 12.6 | 12.4 | 1.2 | 8.8 |

### Example 2

### Whey Demineralisation NF Membranes

Five fouled 4″ NF Polymeric membranes were removed from a whey demineralisation line. Before regeneration, initial permeate flow rate (GPM), initial total dissolved solids (TDS) and initial pressure measurements were taken. The results are shown in Table 6.

Before selecting an enzyme for use in the regeneration, an exemplary membrane module was sent for an autopsy study to determine the composition of the fouling layer. The results indicated the presence of a mineral matrix with proteins and biofilm. The following regeneration steps were used in accordance with these findings.

The remaining four membrane modules were immersed overnight in a tank containing two litres of Reflux E2001 enzyme solution (protease and lipase) in 100 litres of a 1% alkaline solution (Reflux B615). The temperature of the solution was initially increased to 50° C., but not maintained. The pH of the enzyme solution was adjusted to be in the range of 9 and 10. The solution was agitated by application of compressed air by a centrifugal pump designed to deliver 200 psi. The tank comprised a line of apertures of about 2 mm in diameter spaced about 10 cm apart in a pipe positioned about 20 cm from the base of the tank.

After 24 hours, membranes were removed from the tank, rinsed with water and installed in pressurised vessels. The CIP regime shown in Table 5 was selected according to the autopsy results. An acid rinse was employed first to remove the minerals from the foulant.

TABLE 5
Acid/Caustic/Sanitiser CIP Regime

| | | Chemical | Time | Temp | |
|---|---|---|---|---|---|
| Step | Solution | % | (min) | (° C.) | pH Limits |
| 1. Water Flush | | | 6 | | |
| 2. Acid Recirculation | Reflux | 0.25 | 20 | 50 | 1.8-2.0 |
| 3. Water Flush | R400 | | 6 | | |
| 4. Alkali Recirculation | Reflux | 0.2 | 30 | 50 | 10.8-11.0 |
| 5. Water Flush | B615 | | 6 | | |
| 6. Sanitiser | *Perform | 0.1 | 10 | 35 | 3.5-4.5 |
| 7. Water Flush | | | 6 | | |

*Perform is a hydrogen peroxide and per acetic acid formulated sanitiser that attacks biofilm.

The permeate flow of the membrane and TDS were monitored. The regeneration results are shown in Table 6. The results show a flow recovery rate of around 92% while salt rejection rate was around 99% following regeneration.

TABLE 6
Initial and Final Data

| | Permeate | | | | | |
|---|---|---|---|---|---|---|
| | Flow (gpm) | | % Flow | Pressure | Rejection % | |
| Module # | Initial | Final | Recovery | (Bar) | Initial | Final |
| 1 | 2.4 | 4.6 | 92 | 5 | 93 | 99 |
| 2 | 2.2 | 4.2 | 91 | 5 | 91 | 99 |
| 3 | 2.4 | 4.6 | 92 | 5 | 91 | 98 |
| 4 | 2.4 | 4.6 | 92 | 5 | 95 | 99 |

To calculate the regenerated membrane integrity, a comparison was undertaken with a brand new membrane. The integrity percentages are listed in Table 7.

TABLE 7
Module Integrity Data

| | Recovered | Virgin | Membrane |
|---|---|---|---|
| Module # | Flow (gpm) | Flow (gpm) | Integrity % |
| 1 | 4.5 | 5 | 92 |
| 2 | 4.2 | 5 | 84 |
| 3 | 4.6 | 5 | 92 |
| 4 | 4.6 | 5 | 92 |

The membranes were weighed before and after regeneration to evaluate the amount of foulant removed during the process. An average of 0.5 kilograms (about 13 wt % of the fouled membrane) of solid foulant was removed as shown by the results in Table 8.

TABLE 8
Weight Analysis

| | Weight (kg) | | Weight Removed | % Weight |
|---|---|---|---|---|
| No. | Initial | Final | (kg) | Removed |
| 1 | 3.99 | 3.44 | 0.55 | 14 |
| 2 | 3.66 | 3.23 | 0.43 | 12 |
| 3 | 3.92 | 3.41 | 0.51 | 13 |
| 4 | 3.88 | 3.39 | 0.49 | 13 |

### Example 3

### Orange Juice Clarification Membranes Regeneration

Three membrane modules fouled with orange juice were collected. The membranes were Ultrafiltration polysulphone 6.3″ with a slight yellow tinge from the orange juice processing. The initial permeate flow rate of the fouled membrane (GPM), initial total dissolved solids (TDS) and initial pressure measurements were taken. The results are shown in Table 10.

One membrane module was sent for an autopsy study to determine the composition of the fouling layer. The results came back indicating the presence of fibres and clay residuals with mixed monovalent minerals such as sodium and potassium and traces of sucrose. A combination of protease, lipase, amylase and cellulase was considered the best combination to target the foulant (e.g. E4000).

The remaining two membranes were immersed overnight in a tank containing two litres of Reflux E4000 enzyme solution in 100 litres of a 1% alkaline solution (Reflux B615). The temperature of the solution was initially increased to 50° C., but not maintained. The pH was adjusted to be in the range of 9 and 10. The solution was agitated by application of compressed air by a centrifugal pump designed to deliver 200 psi. The tank comprised a line of apertures of about 2 mm in diameter spaced about 10 cm apart in a pipe positioned about 20 cm from the base of the tank.

After 24 hours, the membranes were removed from the tank, rinsed with water and installed in the pressurised vessels. The following CTP regime shown in Table 9 below was selected according to the autopsy results.

TABLE 9
Acid/Caustic CIP Regime

| | | Chemical | Time | Temp | |
|---|---|---|---|---|---|
| Step | Solution | % | (min) | (° C.) | pH Limits |
| 1. Water Flush | | | 6 | | |
| 2. Acid Recirculation | Reflux | 0.25 | 30 | 50 | 1.8-2.0 |
| 3. Water Flush | R400 | | 6 | | |
| 4. Alkali Recirculation | Reflux | 0.2 | 30 | 50 | 10.8-11.0 |
| 5. Water Flush | B615 | | 6 | | |

The permeate membrane flow and TDS were monitored to evaluate the regeneration process. The results are shown in Table 10. The results represent a recovery rate of around 76% while salt rejection rate was 96% following regeneration. The yellow discolouration of the membrane had been removed, so the membrane was similar in colour to a brand new membrane.

TABLE 10
Initial and Final Data

| | Permeate | | | | | |
|---|---|---|---|---|---|---|
| | Flow (gpm) | | % Flow | Pressure | Rejection % | |
| Module # | Initial | Final | Recovery | (Bar) | Initial | Final |
| 1 | 3.6 | 5.5 | 53 | 2 | 86 | 96 |
| 2 | 3.3 | 5.3 | 61 | 2 | 89 | 96 |

To calculate regenerated membrane integrity, a comparison was undertaken with a brand new membrane (Table 11).

TABLE 11
Module Integrity Data

| Module | Recovered | Virgin | Membrane |
|---|---|---|---|
| # | Flow (gpm) | Flow (gpm) | Integrity % |
| 1 | 5.5 | 6.9 | 80 |
| 2 | 5.3 | 6.9 | 77 |

Membranes were weighed before and after regeneration to evaluate the amount of foulant removed during the regeneration process. An average of 0.35 kilograms (about 3 wt % of the fouled membrane) of solid foulant was removed as shown in Table 12.

TABLE 12
Weight Analysis

| | Weight (kg) | | Weight Removed | % Weight |
|---|---|---|---|---|
| No. | Initial | Final | (kg) | Removed |
| 1 | 12.2 | 11.8 | 0.4 | 3 |
| 2 | 11.8 | 11.5 | 0.3 | 3 |

Those skilled in the art will appreciate that the invention described herein is susceptible to variations and modifications other than those specifically described. It is to be understood that the invention includes all such variations and modifications that fall within its spirit and scope.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference to any prior art in this specification is not, and should not be taken as, an acknowledgment or any form of suggestion that that prior art forms part of the common general knowledge.

1. A method of regenerating a fouled membrane, the method including the steps of:
immersing at least a portion of the fouled membrane removed from a process line into an enzyme solution; and
injecting a gas into the enzyme solution to agitate the enzyme solution;
wherein the agitation assists enzyme in the enzyme solution to contact the foulant.

2. The method of claim 1, further including the step of removing the membrane from the process line.

3. The method according to claim 1, wherein the method further includes the step of removing the membrane from the enzyme solution and subjecting the membrane to one or more cleaning steps to remove any residual foulant.

4. The method according to claim 3, wherein the one or more cleaning steps include passing acid and/or alkaline solution though the membrane in a CIP process.

5. The method according to claim 1, wherein the method further includes the step of determining the composition of the foulant on the fouled membrane and selecting an enzyme or enzymes to target said foulant.

6. The method according to claim 1, wherein enzyme in the enzyme solution is selected from one or more of protease, lipase, amylase and cellulase.

7. The method according to claim 1, wherein the temperature of the enzyme solution is increased before and/or during agitation.

8. The method according to claim 7, wherein the temperature of the enzyme solution is increased to an optimum operating temperature for the enzyme or enzymes in solution.

9. The method according to claim 1, wherein the pH of the enzyme solution is selected to be the optimum operating pH for the enzyme or enzymes in solution.

10. The method according to claim 1, wherein the velocity of the gas injected into the tank is in the range of from about 0.1 to about 0.8 ms⁻¹.

11. The method according to claim 1, wherein the gas is injected into the tank as a pulsed stream.

12. The method according to claim 1, further including the step of further agitating the enzyme solution as the enzyme solution is agitated by the gas.

13. The method according to claim 1, further including the step of displacing the fouled membrane in the agitated enzyme solution.

14. The method according to claim 1, wherein the fouled membrane regenerated by the method is a spiral wound membrane.

15. The method according to claim 1, wherein the process line from which the fouled membrane is removed is a dairy food and/or beverage processing line.

16. (canceled)

17. A membrane regenerated by the method according to claim 1.
